(19) United States
(12) Patent Application Publication
(10) Pub. No.: US 2005/0244802 A1
(43) Pub. Date: Nov. 3, 2005

(54) Method for evaluating and pinpointing achievement needs in a school

(76) Inventors: Al MacIlroy, Princeton, NJ (US); Anne E. Conzemius, Oregon, WI (US); Janet K. O'Neill, Madison, WI (US); Toni Morgan, Manhattan Beach, CA (US); Brian Yennie, Hollywood, CA (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/077,474

(22) Filed: Mar. 10, 2005

Related U.S. Application Data
(60) Provisional application No. 60/551,977, filed on Mar. 10, 2004.

(51) Int. Cl. G09B 3/00

(52) U.S. Cl. 434/322

(57) ABSTRACT

A method is provided for evaluating the greatest achievement need in a school for a group of students. The method includes the steps of calculating a plurality of indexes directed to various aspects of student achievement in a particular subject and combining the plurality of indexes to derive a total index for the particular subject. The process is repeated in order to calculate the total index for each subject. Thereafter, the total indexes for each subject are compared and the area of greatest achievement need is determined in response to the comparison.

### CROSS-REFERENCE TO RELATED APPLICATION

This application claims the benefit of U.S. Provisional Application Ser. No. 60/551,977, filed Mar. 10, 2004.

### FIELD OF THE INVENTION

This invention relates generally to educational tools, and in particular, to a method for evaluating and pinpointing areas of greatest achievement need in a school.

### BACKGROUND AND SUMMARY OF THE INVENTION

As a result of the accountability movement, school systems are being held to (or holding themselves to) a number of different academic achievement and improvement standards. These so-called “targets” are often mandated by the federal, state and local governments and impact funding for a school system, the management and oversight of the schools with the school system, and the support provided to the school system by various stakeholders. The expressed purpose of the targets is to ensure that all students succeed and that “no child is left behind.” However, the standardized tests used to assess whether federal and state accountability targets are being met are neither designed to, nor able to give, a complete picture of what all students know and are able to do. Rather, the standardized tests provide judgments on an annual sampling of student performance at selected grade levels. Because standardized tests are not universally administered in all grades, it is impossible to assess the competency of all students and to track improvement of the same students over time.

While having limitations, the use of standardized tests has merits. For example, by analyzing standardized tests, schools may be able to see whether they are generally providing opportunities for students to learn the concepts assessed by the standardized tests and whether the schools are successful at teaching students the concepts assessed by the standardized tests. Further, by reviewing the results of a standardized test, a school may be able to ascertain a picture of the subjects wherein students are generally performing poorly and/or are not being prepared adequately to score on a national par with their peers. Unfortunately, standardized tests do not provide a definitive picture of specific student competencies and learning needs.

For the reasons heretofore described, many school systems are setting their own performance targets. These school systems believe that in order to truly be accountable for the learning of all students, a system of multiple assessments—tied to defined learning standards and grade level expectations—must be used to adequately assess individual student knowledge and skills and to provide a better picture of what specific students know and are able to do. These assessments may include the use of standardized tests, as well as, grade level tests and other diagnostic measures of student competency. It can be appreciated that performance targets have greater potential than accountability targets for providing annual (or more frequent) snapshots of how students at given grade levels are performing to given objectives, as well as, looking at the progress of cohort groups over time.

School systems also believe that being accountable to all students means that individual schools and teachers must have reliable and frequent data to assess how well students are learning and progressing so as to allow the individual schools and teachers to make course corrections in accordance with their assessments. Historically, this level of data has not been available. Consequently, it can be appreciated that a process which enables school teams to evaluate student proficiency through more frequent and specific measurement and analysis is highly desirable.

Therefore, it is a primary object and feature of the present invention to provide a method for evaluating and pinpointing areas of greatest achievement need in a school.

It is a further object and feature of the present invention to provide a method for evaluating and pinpointing areas of greatest achievement need in a school that enables school teams to evaluate student proficiency through more frequent and specific measurement and analysis than prior methods.

It is a still further object and feature of the present invention to provide a method for evaluating and pinpointing areas of greatest achievement need in a school that incorporates specific objectives to be met (indicators), as well as, instructional strategies for helping students meet the indicators, and measures to assess amount and pace of progress toward meeting the indicators.

It is a still further object and feature of the present invention to provide a method for evaluating and pinpointing areas of greatest achievement need in a school that includes the ability to judge both student progress, pace and the effectiveness of strategies of effecting it.

In accordance with the present invention, a method is provided for evaluating the greatest achievement need in a school. The method includes the steps of calculating a plurality of indexes directed to aspects of student achievement in a subject and combining the plurality of indexes to derive a total index for the subject. The calculating and combining steps are repeated for additional subjects and the total indexes for each subject are compared. An area of greatest achievement need is determined in response to the comparison.

The step of calculating the plurality of indexes directed to aspects of student achievement may include the steps determining a gap index for a predetermined group of students; determining a Q-factor index for the predetermined group of students; and determining a delta index for the predetermined group of students. The step of combining the plurality of indexes to derive the total index for the subject includes the additional step of adding the gap index, the Q-factor index and the delta index for the predetermined group of students. The total indexes may be compared to each other or to corresponding predetermined values.

The gap index is determined in response to the difference between a defined academic target and performance by the predetermined group of students. The Q-factor index is determined in response to a number of the predetermined group of students meeting a predetermined competency level or in response to a percentage of the predetermined group of students meeting the predetermined competency level. The delta index is determined in response to the student performance of the predetermined group of students over time.

In accordance with a further aspect of the present invention, a method is provided for evaluating the greatest achievement need in a school for a predetermined group of students. The method includes the steps of calculating a first index in response to the difference between a defined academic target in a subject and performance by the predetermined group of students in the subject and calculating a second index in response to an expected competency level for the predetermined group of students in the subject. A third index is calculated in response to the student performance of the predetermined group of students in the subject over time. The first, second and third of indexes are combined to derive a total index for the subject. The calculating and combining steps are repeated for additional subjects and the total indexes for each subject are compared to determine the subject of greatest achievement need.

The second index is determined in response to a number of the predetermined group of students meeting a predetermined competency level or in response to a percentage of the predetermined group of students meeting a predetermined competency level. The step of comparing the total indexes may include the additional step of comparing the total indexes to each other or to corresponding predetermined values.

In accordance with a still further aspect of the present invention, a method is provided for evaluating an area of greatest achievement need in a school for a predetermined group of students. The method includes the steps of determining first, second and third indexes. The first index is determined from the difference between a defined academic target in a first subject and performance by the predetermined group of students in the first subject. The second index is determined from an expected competency level for the predetermined group of students in the first subject. The third index is determined from the performance by the predetermined group of students in the first subject over time. The determining steps are repeated for at least an additional subject. Fourth indexes are determined in response to the first, second and third indexes of a corresponding subject.

The second index is determined in response to a number of the predetermined group of students meeting a predetermined competency level or in response to a percentage of the predetermined group of students meeting a predetermined competency level. The method may include the additional step of comparing the fourth indexes for the subjects to determine a subject of greatest achievement need. The fourth indexes may be compared to each other or to predetermined values.

### BRIEF DESCRIPTIONS OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1 is a flow chart of a method in accordance with the present invention;

FIG. 2 is a table showing exemplary data calculated in accordance with the method of the present invention;

FIG. 3 is a flow chart of a method for calculating a Gap Index in accordance with the present invention;

FIG. 4 is a flow chart for calculating a Q Factor Index in accordance with the present invention; and

FIG. 5 is a flow chart for calculating a Delta Index in accordance with the present invention.

### DETAILED DESCRIPTION OF THE DRAWINGS

It is intended that the method of the present invention enable educators to evaluate and pinpoint areas of greatest achievement need (hereinafter referred to as “Needs Analysis”) in an academic setting. More specifically, the methodology of the present invention allows educators to conduct Needs Analysis at multiple altitudes and to view student performance with respect to multiple targets to which the students are accountable. This process, in turn, allows the educators to determine the students' greatest areas of need. Although the students' greatest area of need is typically determined at district and/or school altitudes, the Needs Analysis of the present invention may be conducted on any disaggregated group—determined by grade level, department, teacher, and/or identified demographic subgroups—as desired or appropriate. By way of example, the Needs Analysis methodology of the present invention may be applied in the following manners:

1. Accountability Analysis

Accountability Analysis bases Needs Analysis on various measurement tools, measurement scales and achievement and/or progress/improvement targets mandated at federal and state levels that impact the school district and school altitudes. Accountability Analysis is usually based on a year-to year comparison of student performance at the same grades on the same measurement tools. Successive year evaluation can be helpful in identifying program strengths and weaknesses. For example, patterns of poor performance in successive years at the same grade level(s) can indicate program deficiencies, such as lack of curriculum alignment with assessment objectives or improper vertical curriculum articulation. However successive year evaluation cannot look at performance of specific groups of students over multiple years. In order to ensure student performance is sustained or advanced at each grade level, longitudinal, or cohort, evaluation is necessary. There is a growing body of evidence to suggest that accountability data should look at student performance through both lenses.

2. Performance Analysis

Performance Analysis bases Needs Analysis on measurement tools, measurement scales and achievement and/or progress/improvement targets established by local school systems and/or schools, impacting the school district and school altitudes. Performance Analysis may include the measurement tools used for Accountability Analysis, using the same or different measurement scales used for Accountability Analysis and/or higher or lower targets used for Accountability Analysis. Performance Analysis may also be based on multiple measures of student performance using a variety of measurement scales. Performance may be based on year-to-year snapshots of student performance at the same grades on the same measurement tools, and/or annual snapshots of cohort group performance. Further, it can be appreciated that Performance Analysis may also include some interim measurements.

3. Goals Analysis

Goals Analysis bases Needs Analysis on measurement tools, measurement scales, results targets and progress targets, connected to various goals corresponding to the areas of greatest need. Goals Analysis, impacting all altitudes—district, school, grade/department and classroom—may mirror or incorporate elements of Performance and Accountability Analysis at school district and school altitudes. Grade level and department goals specifically use measurement tools and measurement scales suited to frequent, ongoing progress checks of same student performance to grade level expectations.

4. Combined Data Analysis

Combined Data Analysis bases Needs Analysis on a comparison of some combination of Accountability, Performance and Goals Analysis as appropriate to uncover the areas of greatest need and determine the degree to which there are similar patterns of student performance to the various targets. Combined Data Analysis enables educators to see short-term evidence that instructional goals and strategies are—or are not—consistent with student improvement toward targets at all altitudes. Combined Data Analysis over a longer term can provide evidence that instructional goals and strategies are or are not effecting positive change at all altitudes.

5. Data Mining

Data Mining extends Needs Analysis at all altitudes to a more detailed statistical analysis, disaggregation and comparison of actual assessment data to determine policy and program factors that might be impeding achievement and progress of various academic, demographic and/or ethnic groups of students

Just as the use of multiple assessments improves the picture of what students know and are able to do, use of multiple criteria to analyze assessment results can more clearly pinpoint the degree to which specific/all students are meeting targets and learning expectations. As such, the Needs Analysis methodology of the present invention is intended to use multiple assessments and multiple criteria to determine:
1. The degree to which schools are meeting all performance targets to which they are accountable;
2. The degree to which performance patterns are consistent among these targets;
3. The areas of greatest need and where to focus resources to meet these targets; and
4. Policies and programs that are either facilitating or hindering progress of various student groups—and make decisions to ensure high performance of all students.

However, a major obstacle to finding greatest area of need using multiple assessments is the inability to accurately combine data from the assessments to establish student competency, growth over time and relative competency and growth among different subjects/different learning objectives. Current methods do not provide a way to do concurrent analysis on different test types (norm or criterion referenced), with different measurement scales to represent performance level, and target types that represent change in performance from one measurement to the next. As such, the Need Analysis of the present invention contemplates the use of a plurality of indexes, hereinafter described, that allow for “normalization” of data from multiple measures and thus the ability to view student performance, to see progress over time, and to compare relative performance in different subjects through a “single lens.”

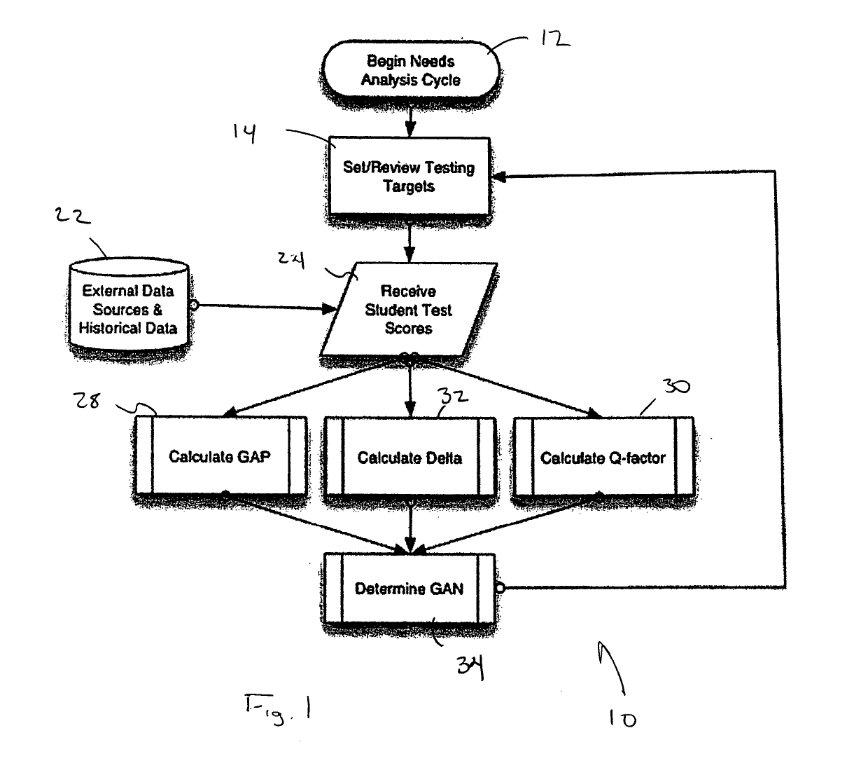

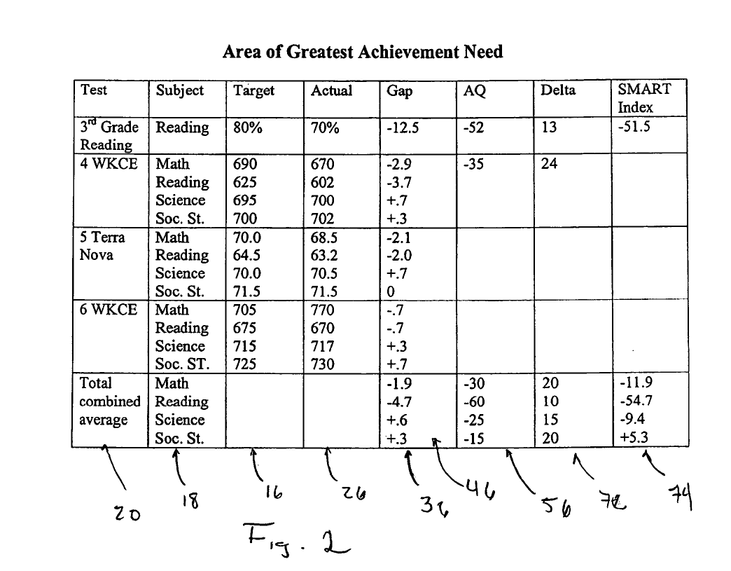

Referring to FIG. 1, a flow chart showing the methodology for evaluating areas of greatest achievement need in a school is generally designated by the reference numeral 10. It is contemplated for the methodology of the present invention to be executed by a computer software program. However, the methodology may be executed in other manners, e.g. manually, with deviating from the scope of the present invention. In operation the Need Analysis method is initialized, block 12, and the targets are defined and reviewed, block 14. Referring to FIG. 2, by way of example, the predetermined targets may take the form of desired standardized test scores, generally designated by the reference numeral 16, for predetermined subjects, generally designated by the reference numeral 18, on predetermined tests, generally designated by the reference numeral 20. Historical data on the predetermined targets and the students actual test scores are reviewed, blocks 22 and 24, respectively. Sample test scores are generally designated by the reference numeral 26. Thereafter, a Gap Index, block 28, a Q Factor Index, block 30, and a Delta Index, block 32, are calculated, as hereinafter described, and an Greatest Area of Achievement Need (GAN), block 34, is obtained.

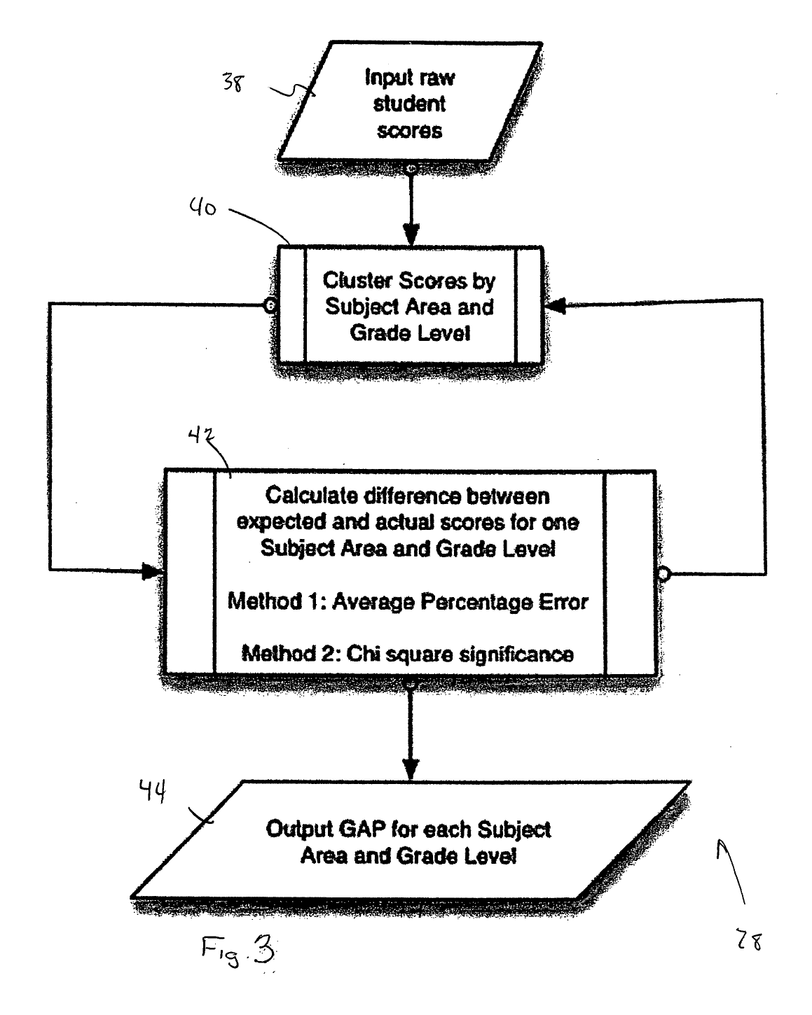

The Gap Index, generally designated by the reference numeral 36 in FIG. 2, is computed as a percent error value between an observed actual score value and an expected target value. Referring to FIG. 3, the Gap Index is calculated, block 28, by receiving the raw student scores, block 38, and clustering the scores by subject area and grade level, block 40. The difference between the expected and the actual scores for each subject area and grade level is calculated according to one of two predetermined methods, block 42, as hereinafter described, and the Gap Index is output for the same, block 44. The percent error may be used to calculate the Gap Index because it allows an index to be computed across different scores (percent passing, mean scale scores, mean national curve equivalent scores, stanine scores). The computation of the percent error involves subtraction of the smaller score value (actual score or target score) from the larger score value (actual score or target score) and then division by associated larger score value. The percent error score (Gap Index) is a signed decimal value that is smaller if the actual and target values are similar and larger if the actual and target number values are different or widely discrepant. The percent error score (Gap Index) is positive if the actual score exceeds the target score and negative if the actual score is less than the target score. The Gap Index scores for each content area are then summed across grades and averaged (n=number of gap scores per content area) to obtain an average gap for each content area across grades. Comparisons determine the content area that exhibits the greatest area of need across grades. Referring to FIG. 2, in the given example, generally designated by the reference numeral 46, the mathematics gap score was −1.9, the reading gap score was −4.7, the average science gap was +0.6 and the social studies average gap score was +0.3. This example suggests that the greatest area of need may be reading since it has the largest negative gap score.

The Gap Index computation may include the following assumptions:
Achievement Indicators can be combined that use different test score metrics (percent passing, mean scale score, mean percentile score, mean national curve equivalent score, stanine, etc.).
Population count weights are assumed equivalent for students within each grade and for students taking different subject area exams within each grade.
Areas of greatest achievement need can be identified by comparing actual observed scores to target expected scores.

The first assumption that achievement indicators can be combined if they use different scoring metrics is not tenable unless the different score metrics have been equated or comparability studies have been conducted to show concordance or equivalence tables between scores using different score metrics. For example, it is known that normal curve equivalence scores can be summed and averaged but that percentile scores cannot be summed and averaged. The Gap Index, as defined, could be used to average normal curve equivalent scores for one grade and percentile equivalent scores for the next grade. What is needed is a normal curve equivalent to percentile conversion (concordance) table to translate each percentile scores to the equivalent normal curve equivalent score. Then, the summing and averaging is computed across grades using the normal curve equivalent metric (original score and comparable equivalent score).

Scale scores are standard scores based on numerical transformations of the original scores based on average scores and standard deviations. The standard formula for a standard score is to subtract the mean from the observed score and divide the score by the standard deviation. The mean score and standard deviation for the scale score definition are arbitrary but can be specified for the required scale score metric (scale scores with a mean of 500 and a standard deviation of 100). For achievement tests, the scale scores are typically computed to show increasing scale scores across grade levels for each content area.

Scale scores, percentile ranks, and normal curve equivalent scores can be appropriately combined across grades if there has been an equating or concordance process that shows the equivalent score relationships to some common or equivalent measurement scales. For example, concordance tables have been developed which show the concordance between scores from the ACT and SAT college entrance scores. These two tests have significantly different score scales but concordance tables can be prepared that show the concordance between the different test scores. Appropriate procedures for this equivalence relationship include equipercentile equating, item response theory equating, and observed score equating, etc. Equipercentile and item response theory equating methods are recommended for this application. Basically this approach translates each specified score to a latent trait or ability estimate. The latent trait ability estimates can then be compared from the percent passing score, the percentile rank, the normal curve equivalent score, and the scale scores.

The ability score in item response theory provides an appropriate metric for comparability since many of the standardized achievement tests and statewide assessment tests have been developed using item response theory.

The second assumption of the Gap Index computation is that population weights are equivalent for the different subject area tests and for different grades. This assumption can be employed as a computational convenience (assuming equal weights of 100 students per subject area per grade) but the mathematically appropriate approach is to use a weighted average. The relevant scores are multiplied by the population weights and a weighted average across grades is computed. The weighted average provides for appropriately weighting the subtest scores by the number of individuals from which the average or total score is based.

The third assumption of the Gap Index computation is that area of greatest achievement need can be identified from comparing the relative summary values for the total combined averages for the different subject areas. This assumption is tenable if comparable score metrics are used (assumption 1) and appropriate weighted averages (assumption 2) have been used in the computation.

Referring back to FIG. 2, the table indicates that the area of greatest achievement need is “reading” with an overall combined average of −4.7 Gap Index. The largest grade level influence on this need is in Grade 3 where the Gap index is −12.5 due to the pronounced discrepancy between the 70% actual and 80% target score. “Reading” is truly an area of need but the greatest area of achievement need is in third grade reading. It is possible that the 70% passing percent actual score could be equivalent to a normal curve equivalent score of 75 and the 80% passing percent target score is equivalent to a normal curve equivalent score of 82. Thus, when the percentage correct scores are given in their normal curve equivalent score units the achievement gap is −7.0 rather than −12.5. ((82−75)/82×100=7.0, −7.0 because the actual is less than the target)

Another statistical model that can be explored for this application is the chi-square model which uses the formula

$${X}^{2} = \sum \frac{{( O - E )}^{2}}{E} \qquad ( Equation 1 )$$

wherein O represents the observed score, E represents the expected score, and X² is the chi-square result.

With this statistical model, the actual score could be the observed score and the expected score could be the target score. The differences between the observed and expected values are squared and divided by the expected value (target score) for each tabled value. In comparison to the percent error model, the chi-square model consistently uses the actual and target scores for the observed and expected values respectively. The model provides a statistical test that can be performed at any chosen level of statistical significance (α<0.01 or 0.05) to determine if the observed achievement scores (actual scores) are significantly different than the expected achievement scores (target scores).

The chi-square formulation can also be used for computing statistical tests with frequencies or proportions of individuals classified into different mutually exclusive classes.

The second statistical approach uses multiple t tests of differences between actual mean scores and a specific target mean score (or frequency). The t test approach assumes that each grade is a separate sample and the statistical test determines the difference between the obtained mean score and the target value and the statistical significance of the difference. The t test requires only knowledge of the means and the standard deviation (square root of the variance) of the sampled scores. The computation of the standard deviation would require use of the individual student scores to compute the score variance and standard deviation. This approach provides statistical significance of the difference, computation of the standard error of the mean and confidence limits for the mean difference.

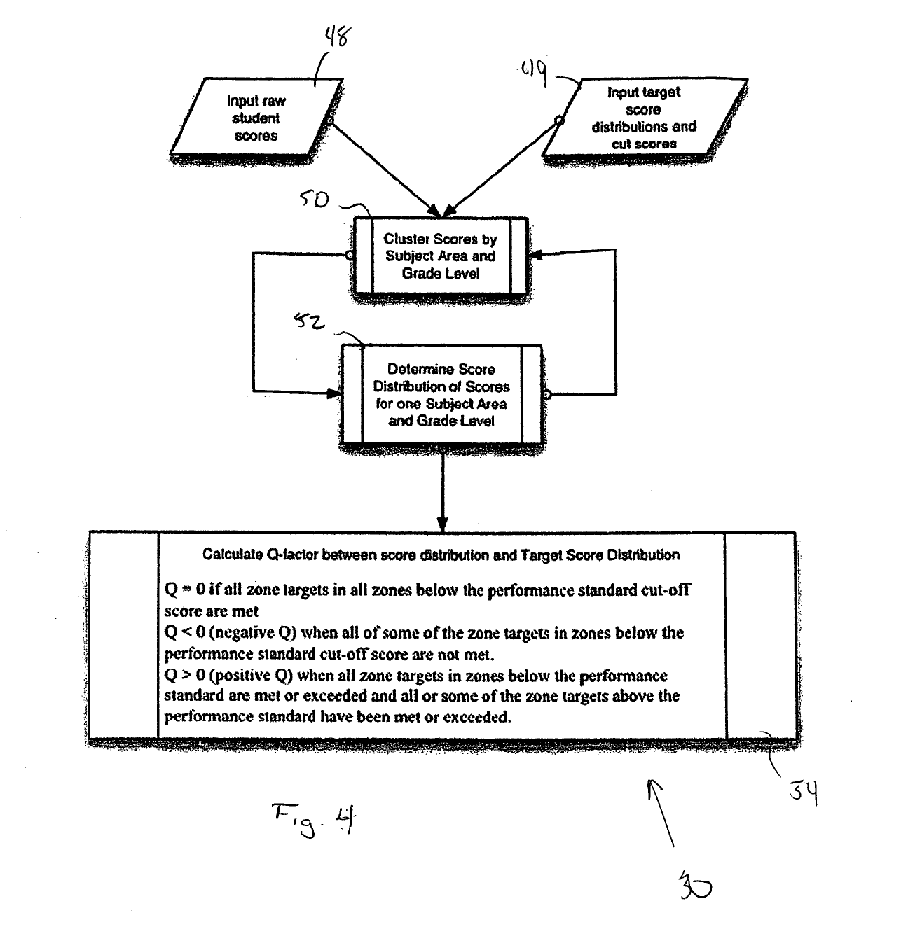

Referring to FIG. 4, the Q Factor Index, block 30, is derived from computing the Gap Index for each of several competency zones. As heretofore described, the Gap Index is calculated by receiving the raw student scores, block 48, and the target score distributions, block 49. The scores are clustered by subject area and grade level, block 50. The difference between the expected and the actual scores for each subject area and grade level is calculated according to one of the previously described methods, block 52. The competency zones are defined in terms of levels of student proficiency. By way of example, the number of competency zones is determined by a local school. Two competency zones with a performance standard (cut score) between the zones is the typical Pass and Fail/Not Pass situation. With three or more competency zones there are typically one or two competency zones that are above the designated performance standard (e.g., Advanced and Proficient) and one or two competency zones that are below the performance standard (Basic and Minimal Mastery). Once the competency zones are defined, the percent of students can be computed or counted that fall within each of the competency zones. The desired percent of students in each competency zone is called the zone target.

The Q Factor Index can take on three values, block 54:
1. Q=0 if all zone targets in all zones below the performance standard cut-off score are met;
2. Q<0 (negative Q) when all of some of the zone targets in zones below the performance standard cut-off score are not met; or
3. Q>0 (positive Q) when all zone targets in zones below the performance standard are met or exceeded and all or some of the zone targets above the performance standard have been met or exceeded.

Sample Q Factor Indexes are generally designated by the reference numeral 56 in FIG. 2. The following assumptions are made for computing the Q Factor Indexes:
From federal and state accountability requirements and local district requirements percentages of students with target levels of proficiency or achievement can be estimated that should fall in each of the multiple competency zones.
The Gap Index can be computed between the target proficiency percent and the actual proficiency percent. Gap Indexes can be aggregated across competency zones. The Q Factor is based on analysis of all of the Gap Indexes for all competency zones.
The Gap Indexes are based on analysis of proportions or probabilities of students falling within different competency zones rather than the actual score levels of the students.
The Q Factor remains negative as long as there is one percent or less of students that have not achieved the performance standard.

The first assumption is dependant upon federal and state accountability targets having been set appropriately with solid understanding and experience of what is truly needed (content, teaching, performance, resources) for students to achieve the designated target proficiency or competency level. The local school district should have much greater knowledge and experience with the expected levels of proficiency for their students and can thus set more realistic and appropriate target levels of proficiency than the political expedient targets for state and federal accountability. If appropriately set, the accountability targets for proficiency levels can be accurate and useful.

The second assumption is based on determining differences between the target and actual percent of students falling within any competency zone.

The third assumption changes the focus of the Gap Index scores from means, percent passing, percentiles and normal curve equivalents to comparing proportional frequencies within designated competency zones. This makes a change from measures that have ordinal (greater and less than) and interval properties (ability and proficiency scores, Rasch calibration values, achievement score scales) to measures that are categorical or nominal (frequencies or proportions within competency zones). Thus, the statistics that can be used to determine statistical significance change from T tests and F tests for interval measures to sign and run tests for ordinal measures to chi-square tests for the categorical or nominal groups. Likewise, the measures of association or correlation change from the Pearson product moment correlation for interval data to the rank-order correlations for ordinal data to contingency table correlations (phi coefficients). The third assumption provides restrictions or boundary values on the types of measures of central location, dispersion, correlation, and statistical significance that can be used with the data. Within the boundaries of contingency table and nominal data classification this assumption is fully tenable.

The fourth assumption is that the Q Factor remains negative as long as there is one percent or fewer individuals that have not attained the performance standard. The importance of this assumption given the current political and accountability focus for education is understandable. Given the wide range of ability and proficiencies that are present in each grade and the increasing breadth of these ability and proficiency levels as one proceeds from grade one to grade 8, it is unlikely that the this number of students or percent of students below the performance standard will be reduced to zero percent or zero students. Q Factor summaries and analysis will likely involve negative Q values (identifiable counts or percent of students falling below the performance standard) particularly in the initial years of high stakes accountability. A negative Q Factor indicates that all students have not met the specified performance standard.

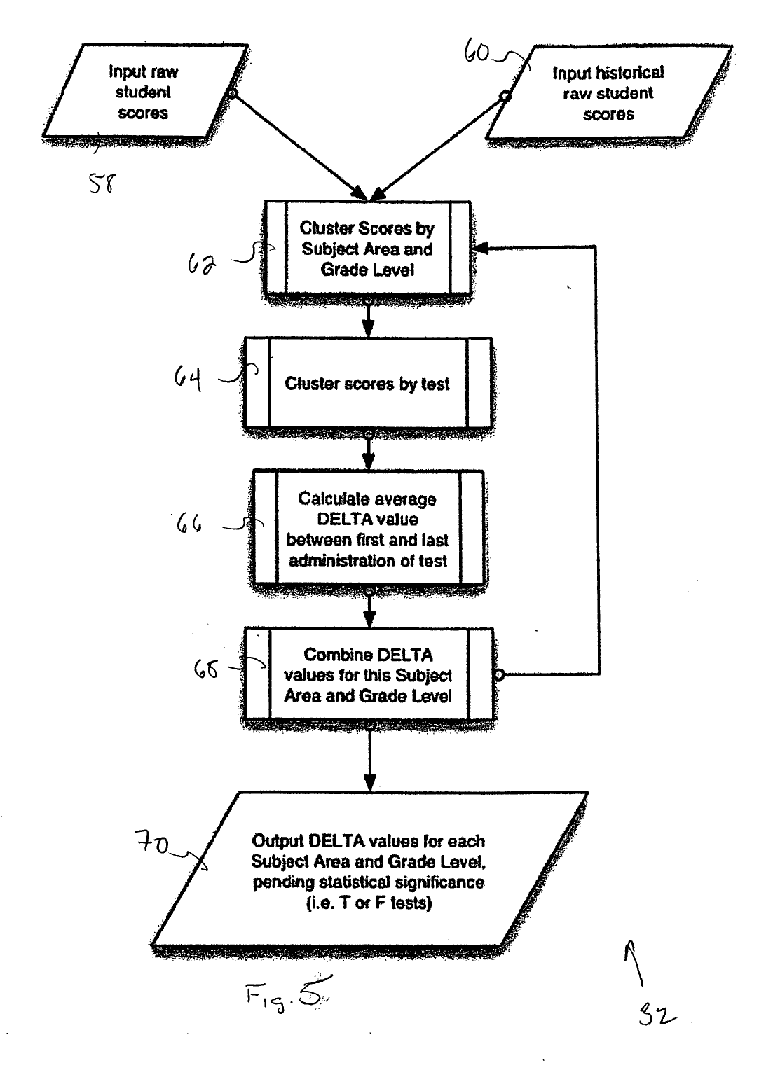

Referring to FIG. 5, the Delta Index, block 32, is defined as a single number (positive or negative) that serves as a measure of the amount/degree of change from the first administration of a measure to the current administration of the measure. A negative Delta Index indicates a decline in achievement between the two measures administered at different points in time. A positive Delta Index indicates an increase in achievement between the two measures administered at different points in time.

The Delta Index, block 32, is calculated by receiving the raw student scores, block 58, and the historical raw student scores, block 60. The scores are clustered by subject area and grade level, block 62, and then by the test taken by the students, block 64. Thereafter, the average Delta Index is calculated, block 66, for the time period between the first and the last administration of the test and the calculated Delta Indexes are combined for a particular subject area and grade level, block 68. The process is repeated for each subject area and grade level. The Delta Index values for each subject area and grade level are provided pending a determination of statistical significance, block 70, as hereinafter described. Sample Delta Index values are generally designated by the reference numeral 72 in FIG. 2.

The Delta Index is based on the following assumptions:
A single number can represent the difference between achievement proficiency measured at two points in time
A large negative Delta Index shows a high degree or rate of decline in student achievement
A large positive Delta Index shows a high degree or rate of improvement in student performance.

The first assumption is tenable if the achievement score metric is the same at the two different points in time. Possible achievement metrics could be percent of students that are proficient, mean scale scores, and mean normal curve equivalent scores, but not mean percentile scores (as noted above). The Delta Index should specify the type of achievement metric being used for the comparison.

A statistical significance test should also be conducted to determine whether the amount or degree of change is based on a meaningful construct-relevant achievement change or just the result of random fluctuations in scores from different occasions or from different groups. For statistical measurement, it is recommended that an F test or T test for differences between means, or a significance test of differences in proportions be used. The recommended alpha significance level is 0.05. The F test and the T test require raw score data values for each of the two measurement occasions. The variance of scores across each occasion is computed, as well as, the standard deviation (square root of the test variance). The counts of scores for each occasion are required. For proportion data chi-square, T test and F tests can also be used where the proportion is the percentage of individuals that are proficient on the two different test occasions. In the case where the scores are dichotomous (pass/fail, yes/no) one category of response can be assigned a score of 1 and the other category assigned a score of 0. The score mean of dichotomous scores is the percent or proportion of individuals assigned a score of 1. Thus, the proportions can be interpreted as the means of dichotomous variables. There are also several other statistical approaches for analysis of contingency table data such as the chi-square and log-linear models.

The second and third assumptions are tenable when the definition of a large value either positive or negative can be defined. The definition of a large value (either positive or negative) value should based on a statistical criterion with an alpha level of 0.05 using the standard error of the target achievement indicator measure

Due to random fluctuations and measurement errors (both systematic and random), it is often possible to show no change between measurement occasions when there is really a change or to show a significant change between measurement occasions when there is really no change. If there are significant gains in achievement for a particular year, it may be difficult to sustain the same degree of achievement gain on successive years. Often plateaus are found in achievement data and achievement gains charted over time. The Delta Index may need to be computed between increasingly longer time spans to allow for measurement of the true achievement changes rather than the yearly fluctuations of achievement increases and decreases. The need is to determine the achievement trend lines and determine if the trends are positive or negative. Repeated measures analysis of variance and time series analyses are statistical approaches that investigate statistical significance of variations in scores over time.

The Smart Index, generally designated by the reference numeral 74 in FIG. 2, is defined as a sum of the Gap Index, Q Factor, and Delta Index. The subject with the largest negative Smart Index or the smallest positive Smart Index is the Greatest Area of Achievement Need (GAN), block 34, FIG. 2. The Smart Index is based on the following assumptions.
It is possible to sum the Gap, Q Factor, and Delta Indices and this sum is a meaningful number.
The Greatest Area of Achievement Need should be identified by the largest negative Smart Index
If there are no negative Smart Indexes then the Greatest Area of Achievement Need is the smallest positive Smart Index.

Alternatively, it is contemplated the indexes heretofore described serve as indicator variables that can be viewed with their variation and uniqueness in concert to determine the area or areas that are most likely areas of achievement need. This necessarily requires the programming of the Smart Index to be more complicated but it also maintains the true complexity of solving the achievement improvement problem. Using the indicator variable approach, the three indexes would be maintained separately and indicator flags would be given for each index to determine areas for particular focus.

As heretofore described, various indexes have been developed that provide a computationally efficient, easy to implement, and easy to explain evaluation approach for pinpointing areas of greatest achievement need in the schools. It is believed that a general quantitative approach has considerable merit for a first level review and interpretive heuristic device that can be used by school administrators, teachers, and educational consultants without additional statistical training and explanations. A computational approach can be explained simply and implemented in software algorithms to determine achievement areas that are most in need of improvement and to give tools for monitoring achievement gains toward desired standards and district achievement targets and goals.

Various modes of carrying out the invention are contemplated as being within the scope of the following claims particularly pointing and distinctly claiming the subject matter that is regarded as the invention

1. A method for evaluating the greatest achievement need in a school, comprising the steps of:
calculating a plurality of indexes directed to aspects of student achievement in a subject; and
combining the plurality of indexes to derive a total index for the subject;
repeating the calculating and combining steps for additional subjects;
comparing the total indexes for each subject; and
determining an area of greatest achievement need in response to the comparison.

2. The method of claim 1 wherein the step of calculating the plurality of indexes directed to aspects of student achievement includes the steps:
determining a gap index for a predetermined group of students;
determining a Q-factor index for the predetermined group of students; and
determining a delta index for the predetermined group of students.

3. The method of claim 2 wherein the step of combining the plurality of indexes to derive the total index for the subject includes the step of adding the gap index, the Q-factor index and the delta index for the predetermined group of students.

4. The method of claim 3 wherein the step of comparing the total indexes includes the steps of comparing the total indexes to each other.

5. The method of claim 3 wherein the step of comparing the total indexes includes the step of comparing each total index of a corresponding subject to a predetermined value.

6. The method of claim 2 wherein the gap index is determined in response to the difference between a defined academic target and performance by the predetermined group of students.

7. The method of claim 2 wherein the Q-factor index is determined in response to a number of the predetermined group of students meeting a predetermined competency level.

8. The method of claim 2 wherein the Q-factor index is determined in response to a percentage of the predetermined group of students meeting a predetermined competency level.

9. The method of claim 2 wherein the delta index is determined in response to the student performance of the predetermined group of students over time.

10. A method for evaluating the greatest achievement need in a school for a predetermined group of students, comprising the steps of:
calculating a first index in response to the difference between a defined academic target in a subject and performance by the predetermined group of students in the subject;
calculating a second index in response to an expected competency level for the predetermined group of students in the subject;
calculating a third index in response to the student performance of the predetermined group of students in the subject over time;
combining the first, second and third of indexes to derive a total index for the subject;
repeating the calculating and combining steps for additional subjects; and
comparing the total indexes for each subject to determine the subject of greatest achievement need.

11. The method of claim 10 wherein the second index is determined in response to a number of the predetermined group of students meeting a predetermined competency level.

12. The method of claim 10 wherein the second index is determined in response to a percentage of the predetermined group of students meeting a predetermined competency level.

13. The method of claim 10 wherein the step of comparing the total indexes includes the steps of comparing the total indexes to each other.

14. The method of claim 10 wherein the step of comparing the total indexes includes the step of comparing each total index to a predetermined value.

15. A method for evaluating an area of greatest achievement need in a school for a predetermined group of students, comprising the steps of:
determining a first index from the difference between a defined academic target in a first subject and performance by the predetermined group of students in the first subject;
determining a second index an expected competency level for the predetermined group of students in the first subject;
determining a third index the performance by the predetermined group of students in the first subject over time;
repeating the determining steps for at least an additional subject; and
determining fourth indexes for each subject in response to the first, second and third indexes of a corresponding subject.

16. The method of claim 15 wherein the second index is determined in response to a number of the predetermined group of students meeting a predetermined competency level.

17. The method of claim 15 wherein the second index is determined in response to a percentage of the predetermined group of students meeting a predetermined competency level.

18. The method of claim 15 further comprising the additional step of comparing the fourth indexes for each subject to determine the subject of greatest achievement need.

19. The method of claim 18 wherein the step of comparing the fourth indexes includes the steps of comparing the fourth indexes to each other.

20. The method of claim 10 wherein the step of comparing the fourth indexes includes the step of comparing each fourth index to a predetermined value.
